(19) United States
(12) Patent Application Publication
(10) Pub. No.: US 2011/0316546 A1
(43) Pub. Date: Dec. 29, 2011

(54) Zero Insertion Force Scrubbing Contact

(76) Inventors: Christopher James Bruno, Hudson, MA (US); David Nathaniel Scott, Newbury Park, CA (US); Bruce Leon Cowgill, Newbury Park, CA (US)

(21) Appl. No.: 12/825,998

(22) Filed: Jun. 29, 2010

(51) Int. Cl. G01N 27/416

(52) U.S. Cl. 324/426

(57) ABSTRACT

A contact assembly is described for testing a storage cell with a probe configured to flex in an outward direction, in response to a vertical application of force, to scrub a tab on the storage cell at a zero insertion force. The contact assembly comprises a contact structure configured to flex in an outward direction to scrub and to pierce a tab of the storage cell; a board, wherein a juxtaposition of the board to the contact structure defines an opening configured to receive the tab of the storage cell; and a device configured to move the contact structure, to a position in which the opening is closed, to cause the contact structure to scrub and to pierce the tab on the storage cell.

### TECHNICAL FIELD

This patent application relates generally to testing a storage cell by a zero insertion force scrubbing.

### BACKGROUND

In order to test a storage cell (e.g., an electrochemical cell, a battery, and so forth), a reliable electrical connection is established between a probe tip of a probe and a contact pad on the top of the storage cell. A contact pad on a storage cell is commonly made of aluminum or copper alloy with a nickel plating with gold plating. The contact pad typically has an oxide build-up (“oxidation layer”) on its surface. The oxidation layer is non-conductive and presents a barrier to making a solid electrical connection during test. Probe tips must, therefore, penetrate this oxidation layer to establish a reliable electrical connection with the contact pad. To ensure that a probe tip will be able to penetrate the oxidation layer, the probe tip is shaped and mechanically actuated to pierce the oxidation layer. Additionally, a probe tip may be moved across a contact pad to further test the electrical properties of the contact pad. This mechanical action is termed “scrub.”

One way of establishing a strong electrical connection between the contact pad and the probe tip is through a “jaw-like” structure, in which two jagged edged testing arms clamp down on a contact pad (e.g., a tab) of a storage cell to establish an electrical connection with the contact pad. Another way of testing a storage battery is through the use of “pogo pins,” which “touch down” (i.e., make contact with) a contact pad during testing.

### SUMMARY

In one aspect of the present disclosure, a contact assembly for testing a storage cell, comprises: a contact structure configured to flex in an outward direction to scrub and to pierce a tab of the storage cell; a board, wherein a juxtaposition of the board to the contact structure defines an opening configured to receive the tab of the storage cell; and a device configured to move the contact structure, to a position in which the opening is closed, to cause the contact structure to scrub and to pierce the tab on the storage cell.

Implementations of the disclosure may include one or more of the following features. In some implementations, the tab is scrubbed at a zero insertion force. In other implementations, a portion of the contact structure comprises a raised feature and a flexure configured to flex in an outward direction upon a vertical application of force to the contact structure. In still other implementations, the flexure causes the raised feature of the contact structure to scrub and to pierce a surface of the tab. In some implementations, the device is further configured to a move the board to a position in which the opening is closed.

In other implementations, the contact assembly further comprises: a test system configured to receive one or more of the contact structure, the board and the device, for testing of the storage cell. In some implementations, the raised feature comprises one or more of a conducting material. In other implementations, the contract structure comprises one or more scalloped features configured to control a contact force applied to the tab on the storage cell. In still other implementations, the raised feature comprises a first raised feature, and wherein the contact structure further comprises a first contact finger and a second contact finger, wherein the first contact finger comprises the first raised feature and the second contact finger comprises a second raised feature.

In some implementations, the first raised feature of the first contact finger and the second raised feature of the second contact finger are each configured to pierce and to scrub the tab on the storage cell. In some implementations, the contract structure comprises an individually replaceable contact structure. In some implementations, the raised feature comprises an embossed, metallic contact tip. In other implementations, the contact structure comprises a first contact structure, and the contact assembly further comprises: a second contact structure, wherein the first contact structure and the second contact structure are arranged in a contact array on a support board. In still other implementations, the zero insertion force comprises a force that maintains a structure of the tab of the storage cell.

In another aspect of the disclosure, a method of testing a storage cell comprises receiving a tab of the storage cell into a space between a board and a contact structure; moving the contact structure to a position in which the space is closed; and causing the contact structure to pierce and to scrub the tab on the storage cell using a raised feature on the contact structure.

Implementations of the disclosure may include one or more of the following features. In some implementations, scrubbing and piercing are performed at a zero insertion force. The method also comprises applying a vertical force, wherein application of the vertical force causes the contact structure to move in an outward direction, which causes the raised feature to pierce and to scrub the surface of the tab. In other implementations, the raised feature comprises a first raised feature, the contact structure comprises a first contact finger and a second contact finger, and wherein the first contact finger comprises the first raised feature and wherein the second contact finger comprises a second raised feature, and the method further comprises: causing the contact structure to pierce and to scrub a surface of the tab on the storage cell with the first raised feature and the second raised feature. In some implementations, the raised feature comprises a conducting material. Implementations of this aspect of the present disclosure can include one or more of the foregoing features.

In yet another aspect of the disclosure, a contact assembly for testing a storage cell, comprises: a probe configured to flex in an outward direction, in response to a vertical application of force, to scrub a tab on the storage cell at a zero insertion force. Implementations of this aspect of the present disclosure can include one or more of the foregoing features.

Any two or more of the features described in this patent application, including this summary section, may be combined to form embodiments not specifically described in this patent application.

The details of one or more examples are set forth in the accompanying drawings and the description below. Further features, aspects, and advantages will become apparent from the description, the drawings, and the claims.

### DESCRIPTION OF DRAWINGS

FIG. 1 is a perspective view of a probe for testing a storage cell.

FIG. 2 is a side view of a contact structure of a probe.

FIG. 3 is a side view of an array of probes.

FIG. 4 is an exploded side view of a contact assembly.

FIG. 5 is a perspective view of a formation bay assembly in a test rack.

FIG. 6 is a cross-sectional view of a contact assembly in a formation bay assembly.

FIG. 7 is a perspective view of a formation bay assembly.

FIGS. 8A, 8B are cross-sectional views of a contact structure testing a storage cell.

### DETAILED DESCRIPTION

Described herein is a contact assembly for testing storage cells, including, but not limited to, batteries (e.g., lithium ion batteries). The contact assembly includes a plurality of probes, which test the storage cells by scrubbing, with a zero insertion force, a portion of the storage cell protruding from a side of the storage cell (e.g., a “tab”).

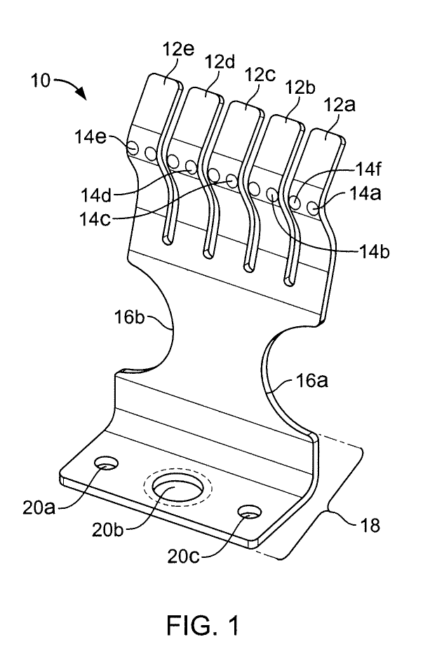

Referring to FIG. 1, testing probe 10 includes a plurality of contact structures 12a-12e. Contact structures 12a-12e include raised features 14a-14e that rub against, and make contact with, a surface of a tab during testing of a storage cell. In some examples, a single contact structure (e.g., contact structure 12a) includes a plurality of raised features 14a, 14f that are configured to test (e.g., simultaneously) the tab of a storage cell. During testing of a storage cell, raised features 14a-14e make contact with a tab on the storage cell at the same time, providing redundancy in testing, as described in further detail below. Because testing probe 10 includes a plurality of contact structures 12a-12e, each with a plurality of raised features 14a-14e, testing probe 10 establishes multiple electronic connections for testing with a tab of storage cell, ensuring that a strong electrical connection is established during test.

Testing probe 10 also includes scalloped features 16a, 16b to control a contact force applied to the tab on the storage cell. Scalloped features 16a, 16b enable contact structures 12a-12e to act as a flexure with a precise spring constant, which will produce a contact force on a tab of a storage cell within a pre-defined range of contactor deflection. Testing probe 10 also includes base 18, with a plurality of ring holes 20a-20c for attaching (e.g., screwing, soldering, and so forth) testing probe 10 to a body of the contact assembly, as described in further detail below.

In some examples, raised features 14a-14f are made from a conducting metal (e.g., a phosphorus bronze metal, a brass metal, a copper metal, a bronze metal, a gold metal, and so forth, each of which could be plated with nickel, palladium, gold, and so forth) embossed onto contact structures 12a-12e. The shape of raised features 14a-14e includes, but is not limited to, a circular shape, a rectangular shape, a pyramidal shape, and so forth. Raised features 14a-14e also include a tip, for example, a sharp tip, to break through an oxidation layer of a tab on a storage cell. During testing of a storage cell, raised features 14a-14e make contact with a tab on the storage cell at the same time, providing redundancy in testing. In some examples, a single contact structure (e.g., contact structure 12a) includes a plurality of raised features 14a, 14f that are configured to test (e.g., simultaneously) the tab of a storage cell.

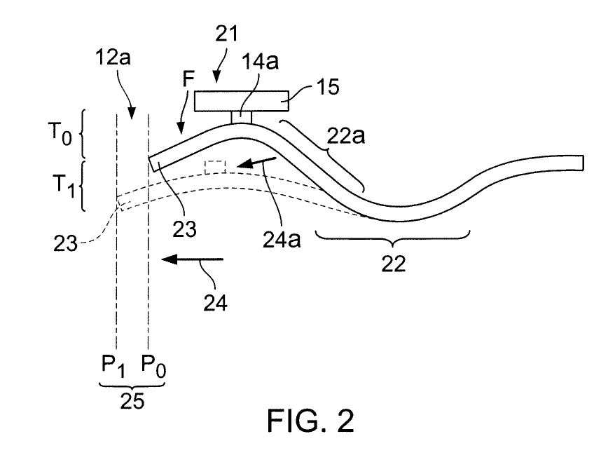

Referring to FIG. 2, contact structure 12a includes flexure 22 that is configured to flex in outward direction 24 upon an application of a force F to contact structure 12a in vertical direction 21. Flexure 22 is made of a flexible material, for example bronze, copper, gold, and so forth. Flexure 22 includes curved portion 22a that is configured to bend in direction 24a as raised feature 14a makes contact with a surface (e.g., a surface of tab 15 of a storage cell being tested). In one particular example, a test system positions contact structure 12a such that raised feature 14a makes contact with tab 15 of a storage cell. The contact between tab 15 and raised feature 14a generates normal force 21. Normal force 21 is a downward force, which causes curvature 22a to extend in direction 24a. As curvature 22a extends in direction 24a, raised feature 14a moves across the surface of tab 15 generating scrub. In the illustrated example of FIG. 2, at time T₀, a vertical force is not applied to contact structure 12a and tip 23 of contact structure 12a is at position P₀. At time T₁, a vertical force F in direction 21 is applied to contact structure 12a. The vertical force causes curvature 22a to extend in direction 24a, which causes contact structure 12a to flex in direction 24. Accordingly, at time T₁, tip 23 of contact structure 12a moves outward in direction 24 to position P₁. Between T₀ and T₁, tip 23 of contact structure 12a is displaced horizontal distance 25 relative to P₀.

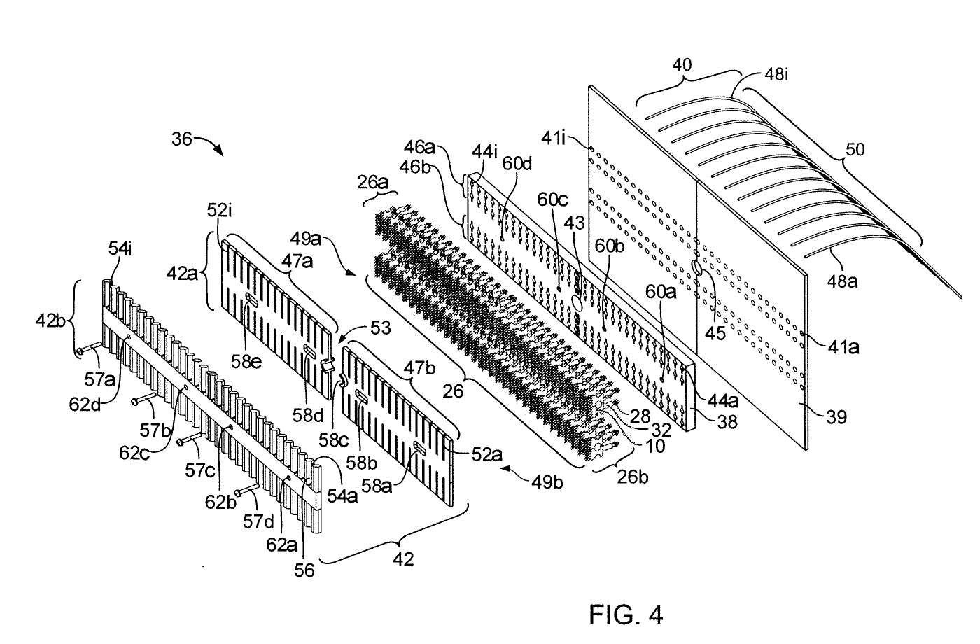

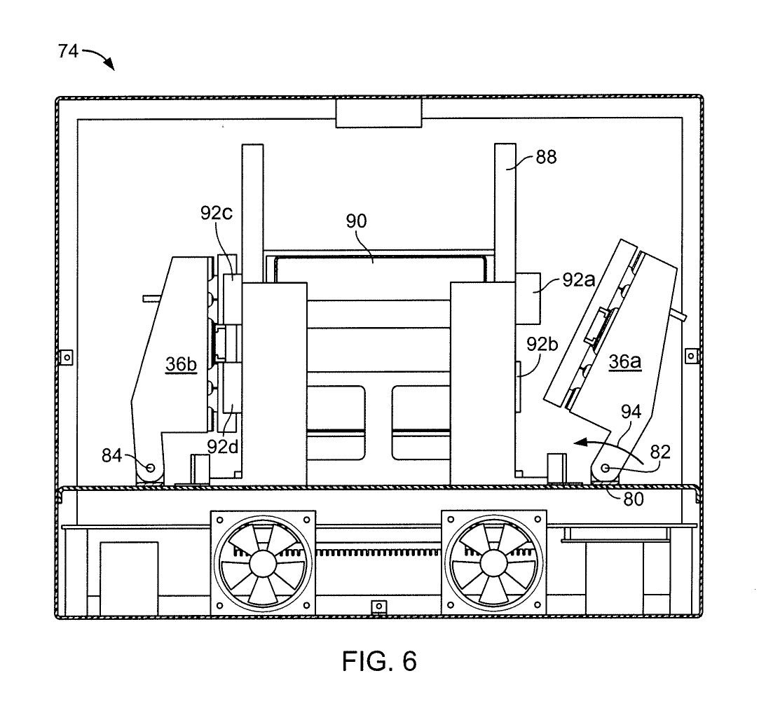

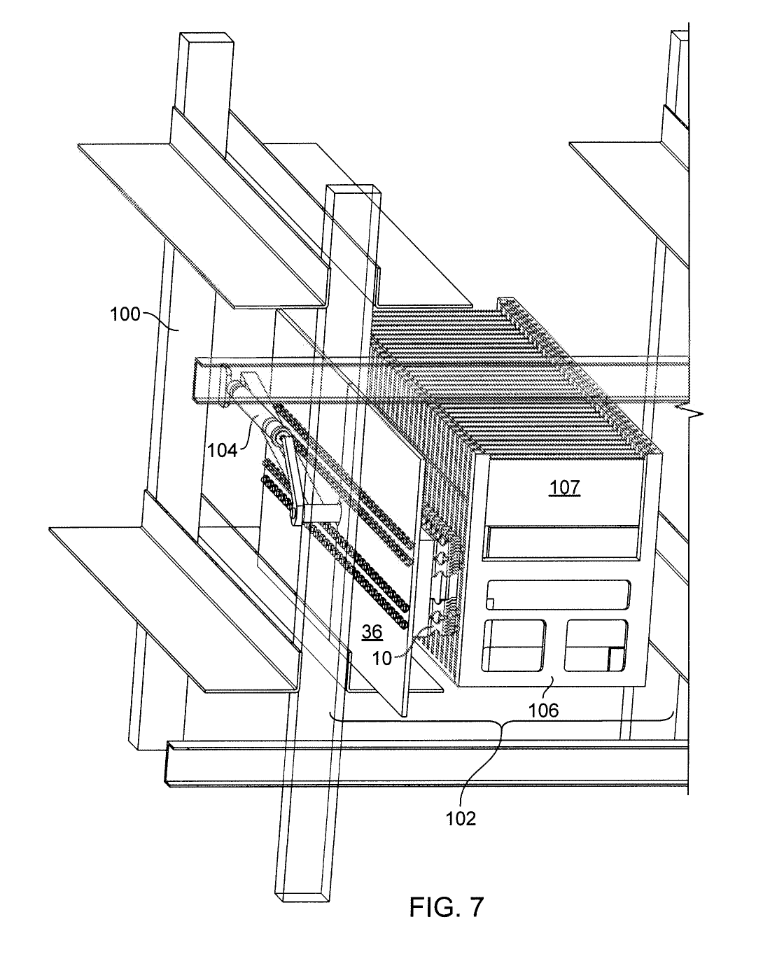

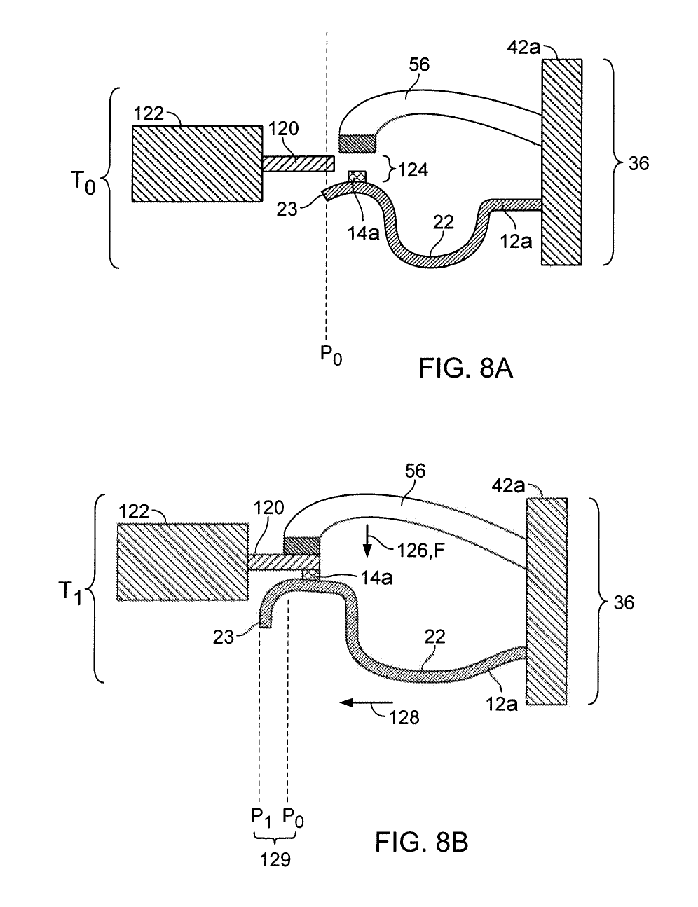

Referring to FIG. 8A, in contact assembly 36, contact structure 12a and raised guide 56 (FIG. 4) are fastened to grid block 42a, as described in further detail below. Testing space 124 (e.g., a space in which a tab of a storage cell is inserted for testing) exists in the area between raised guide 56 (FIG. 4) and raised feature 14a of contact structure 12a. In the illustrated example of FIG. 8A, at time T₀, tip 23 of contact structure 12a is at position P₀. Tab 120 of storage cell 122 is moved into testing space 124 by a robotic device (e.g., robotic arm 104 (FIG. 7) of contact assembly 36, a robot moving tote 88 (FIG. 6) in a horizontal direction until tab 120 is situated in testing space 124, or any combination thereof). When tab 120 is inserted into testing space 124, contact assembly 36 is in an “open position,” in which raised guide 56 and raised feature 14a do not make contact with tab 120. Because raised guide 56 and raised feature 14a do not make contact with tab 120, no force is exerted on tab 120 when tab 120 is inserted into test space 124 at T₀. That is, tab 120 is inserted into test space 124 at a zero insertion force. Because of the zero insertion force, tab 120 is not damaged during testing of the storage cell.

In another example, contact assembly 36 is in a “closed position,” in which raised feature 14a and raised guide 56 make contact with each other. Tab 120 in inserted into contact assembly 36 when contact assembly is in the closed position. In this example because raised feature 14a and raised guide 56 are already closed, a force (e.g., non-zero insertion force) is used to insert tab 120 between raised feature 14a and raised guide 56. Because of the force, tab 120 may be damaged during insertion between raised feature 14a and raised guide 56, for example, if the surfaces of raised guide 56 and/or raised feature 14a cause damage (e.g., tearing, crinkling, rippling, and so forth) during insertion.

Referring to FIG. 8B, at time T₁ (e.g., as the movement of tab 120 into test space 24 continues), contact assembly 36 is in a “test position,” in which tab 120 is fixed between and makes contact with raised feature 14a and raised guide 56. The contact of tab 120 with raised feature 14a and raised guide 56 generates normal force 126. Normal force 126 exerts a downward force on contact structure 12a. Normal force 126 causes contact structure 12a to pierce an oxidation layer on tab 120. Normal force 126 also causes flexure 22 in contact structure 12a to extend in outward direction 128. The movement of flexure 22 causes tip 23 of contact structure 12a to move distance 129 (e.g., 0.020 inches) in outward direction 128 from position P₀ to position P₁. The motion of flexure 22 extending in direction 128 generates friction between tab 120 and raised feature 14a. The generated friction causes a scrubbing action of tab 120. That is, the application of normal force 126 over distance 129 causes contact structure 12a to translate along tab 120 to scrub tab 120. The piercing and scrubbing of tab 120 establishes an electrical connection between contact structure 12a and storage cell 122. Through the electrical connection, a relatively low contact resistance (e.g., a contact resistance of less than 25 milliohms) is established between contact structure 12a and tab 120 during testing of storage cell 122. Because of the relatively low contact resistance, a minimal amount of energy is lost in the path between tab 120 of storage cell 122 and contact structure 12a of testing probe 10, which allows the test system to efficiently operate with a less resistant connection to tab 120.

In one example, force 126 that is exerted on tab 120 by contact structure 12a (e.g., during scrubbing and/or piercing) is a one pound force. In an example where testing probe 10 has five contact structures 12a-12e, force 126 exerted on tab 120 is five pounds.

Because raised feature 14a establishes an electrical connection with tab 120 at a zero insertion force, the structural integrity of tab 120 is maintained and tab 120 is not damaged by the testing. With the electrical connection established between tab 120 and raised feature 14a, the formation electronics in formation electronics board 39 (FIG. 4) sends test signals to storage cell 122 and receives response signals from storage cell 122 to be tested.

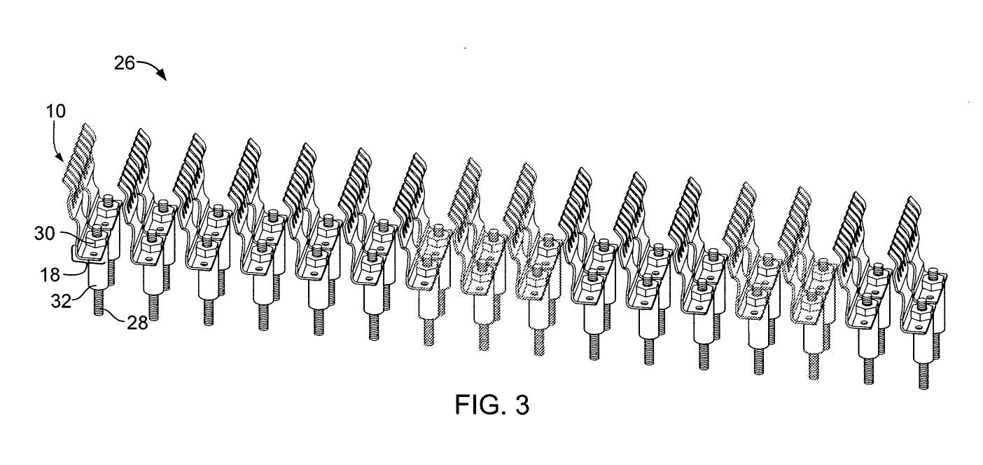

Referring to FIG. 3, array 26 (e.g., an array sixteen testing probes long by two testing probes wide, 2×16) of testing probes 10 is shown. As discussed in further detail, the contact assembly includes array 26 of testing probes and testing probes 10 are arranged in array 26 for placement in the contact assembly. Testing probe 10 includes bolt device 28 (e.g., a screw), which fits through ring hole 20b. Bolt device 28 is attached to base 18 of testing probe 10 by nut 30 (e.g., a lug nut). In some examples, bolt device 28 is encased by casing device 32 that is designed to secure testing probe 10 to a contactor support board in the contact assembly, as described in further detail below.

Referring to FIG. 4, contact assembly 36 includes array 26 of testing probes, contactor support board 38, formation electronics board 39, flexible structure 40, and grid board 42. Contactor support board 38 isolates forces from formation electronics board 39 and from testing probes 10. Because half of testing probes 10 are pushing against tabs of a storage cell in one direction and the other half of testing probes 10 are pushing against the tabs in an opposite direction, the resultant force of testing probes 10 pushing in one direction is cancelled by the other half of testing probes 10 pushing in the opposite direction.

Contactor support board 38 also isolates forces from formation electronics board 39 and from testing probes 10 by counteracting load force from testing probes 10. Testing probe 10 is fastened to contactor support board 38 by a conductive threaded dowel. A normal force applied to a contact structure of testing probe 10 generates a load at the base of testing probe 10. Contactor support board 38 structure absorbs the load from the contact structure. Contactor support board 38 includes a plurality of openings 44a-44i (e.g., holes) into which bolt devices 28 of testing probes 10 are inserted. In some examples, the number of the openings 44a-44i and the placement of the openings 44a-44i correspond to the number of testing probes 10 and the placement of the testing probes 10 in array 26. In the illustrated example of FIG. 4, array 26 includes op array 26a of testing probes 10 and bottom array 26b of testing probes 10. Accordingly, openings 44a-44i in contactor support board 38 are arranged in corresponding top array 46a of openings and corresponding bottom array 46b of openings. Testing probes 10 are fastened to contactor support board 38 by inserting bolt devices 28 into openings 44a-44i in contactor support board 38. Bolt devices 28 are fastened to a side of contactor support board 38 using for example a lug nut or other fastening device. Because each testing probe 10 is individually attached to contactor support board 38, testing probes 10 are individually replaceable.

Contactor support board 38 also includes opening 43 through which a portion of a robotic arm is inserted, as described in further detail below. Contactor support board 38 also includes openings 60a-60d through which grid board 42 is fastened to contactor support board 38, as described in further detail below.

Formation electronics board 39 receives commands, from a testing system (not shown), to initiate execution of routines and functions for testing the storage cell. The execution of test routines may initiate the generation and transmission of test signals to the storage cell and collect responses from the storage cell being tested.

Formation electronics board 39 includes a plurality of contact pads 41a-41i, which provide an electrical path between the formation electronics (e.g., in formation electronics board 39 or in an external testing system) and testing probes 10. The number of contact pads 41a-41i and the placement of contact pads 41a-41i correspond to (i) the number of testing probes 10 and the placement of the testing probes 10 in array 26; and (ii) the number of openings 44a-44i and the placement of openings 44a-44i in contactor support board 38. Based on this configuration, an electrical connection is established between testing probes 10 and contact pads 41a-41i through contactor support board 38. Formation electronics board 39 also includes opening 45 through which a portion of a robotic arm is inserted, as described in further detail below. Opening 45 in formation electronics board 39 corresponds in size and in placement to opening 43 in contactor support board 38, because the robotic arm is attached to contact assembly 36 through opening 45 and through opening 43.

Flexible structure 40 includes a number of flexible beams 48a-48i (e.g., current carrying wires), which flex (e.g., extend) in an outward direction upon a vertical application of pressure to the top of the flexible beams. The flexible beams are made of a flexible material (e.g., a malleable plastic, wire material, and so forth. The number of flexible beams 48a-48i and the placement of flexible beams 48a-48i correspond to the number of and the placement of openings 41a-41i and 44a-44i. In the example where openings 44a-44i of contactor support board 38 are arranged in top array 46a and bottom array 46b, flexible beams 48a-48i are also arranged in corresponding top array 50 and in corresponding bottom array (not shown) of flexible beams 48a-48i. Flexible beams 48a-48i are inserted into openings 41a-41i of formation electronics board 39, and are fastened to a side of formation electronics board 39 by, for example, a bolt device, a lug nut, a ring nut, and/or soldering.

Grid board 42 includes grid board 42a and grid board 42b. Grid board 42a includes a number of openings 52a-52i (e.g., slits) through which testing probe 10 is inserted. The number of slits 52a-52i and the placement of slits 52a-52i correspond to the number of testing probes 10 and the placement of testing probes 10 in array 26. Grid board 42a includes openings 58a-58b and 58d-58e, which correspond in placement and in size to openings 60a-60d in contactor support board 38. Grid board 42a also includes an opening 58c through which a portion of the robotic arm is inserted. The size and the placement of opening 58c correspond to the size and placements of openings 43, 45, through which the robotic arm is also inserted.

In an example, grid board 42a is configured to move in directions 49a, 49b to cause contact structures 12a-12e to move into, and make contact with, the tabs of a storage cell. Grid board 42a includes pieces 47a, 47b. In some examples, pieces 47a, 47b are configured to move in a same direction. In other examples, pieces 47a, 47b are configured to move in an opposite direction.

Opening 58c is configured to receive a shaft (i.e., a tapered shaft, a conical shaft, and so forth) (not shown). Openings 43, 45 are also configured to receive the shaft. A robotic device (not shown) moves the shaft into and out of openings 58c, 43 and 45. In another example, grid board 42a is moved by a cylinder device. As the shaft moves into and out of openings 58c, 43 and 45, a distance of space 53 between pieces 47a, 47b widens and decreases, causing pieces 47a, 47b to move away from and towards each other in directions 49a, 47b. That is, in an example where the shaft is a conical shaft with a cone portion of varying dimensions, as a wider dimension of the cone portion moves into and out of opening 58c, the cone portion causes pieces 47a, 47b to move away from each other in direction 49b and direction 49a, respectively. As a narrower dimension of the cone portion moves into and out of opening 58c, the cone portion causes pieces 47a, 47b to move towards each other in direction 49a and direction 49b, respectively. Openings 58a-58b and 58d-58e include slits to accommodate the movement of grid board 42a relative to gird board 42b.

As grid board 42a moves, contact structures 12a-12e remain fixed in position on contactor support board 38. Because contact structures 12a-12e remain fixed in position on contactor support board 38, the movement of grid board 42a causes an edge of slits 52a-52i to make contact with contact structures 12a-12e, which causes contact structures 12a-12e to move into a position in which contact structures 12a-12e make contact with the tabs of a storage cell. As described in further detail below, grid board 42b includes a non-moveable surface (e.g., raised guide 56). As contact structures 12a-12e are pushed by grid board 42a to make contact with the tabs of a storage cell, the tabs are pushed against raised guide 56, fixing the tabs between contact structures 12a-12e and raised guide 56. Because raised guide 56 is non-moveable, the motion of the tabs being pushed into raised guide 56 generates a normal force in a downward direction. The normal force is exerted on contact structures 12a-12e, which causes contact structures 12a-12e to flex in an outward direction and to scrub a surface of the tabs. Grid board 42b also includes a number of slits 54a-54i. Slits 54a-54i in grid board 42b correspond in number and in placement to slits 52a-52i in grid board 42a. Testing probes 10 are inserted into slits 52a-52i and 54a-54i. Each slit 54a-54i of grid board 42b includes raised guide 56. As described with reference to FIGS. 8A and 8B, testing space 124 is defined by a space between contact structure 12a of test probe 10 and raised guide 56 (e.g., when testing probe 10 is inserted into slits 54a-54i, 52a-52i). Because the position of raised guide 56 does not move as the tab of a storage cell comes into contact with a surface of raised guide 56 in testing space 124, a normal force is generated by the contact of the tab with raised guide 56. The normal force is a downward force, which when exerted on contact structure 12a causes flexure 22 to move in direction 128 (FIG. 8B). Grid board 42 secures array 26a, 26b to contactor support board 38 with bolt devices 57a-57d, which are inserted through openings 62a-62d and 58a-58b and 58d-58e in grid boards 42a, 42b and through openings 60a-60d in contactor support board 38.

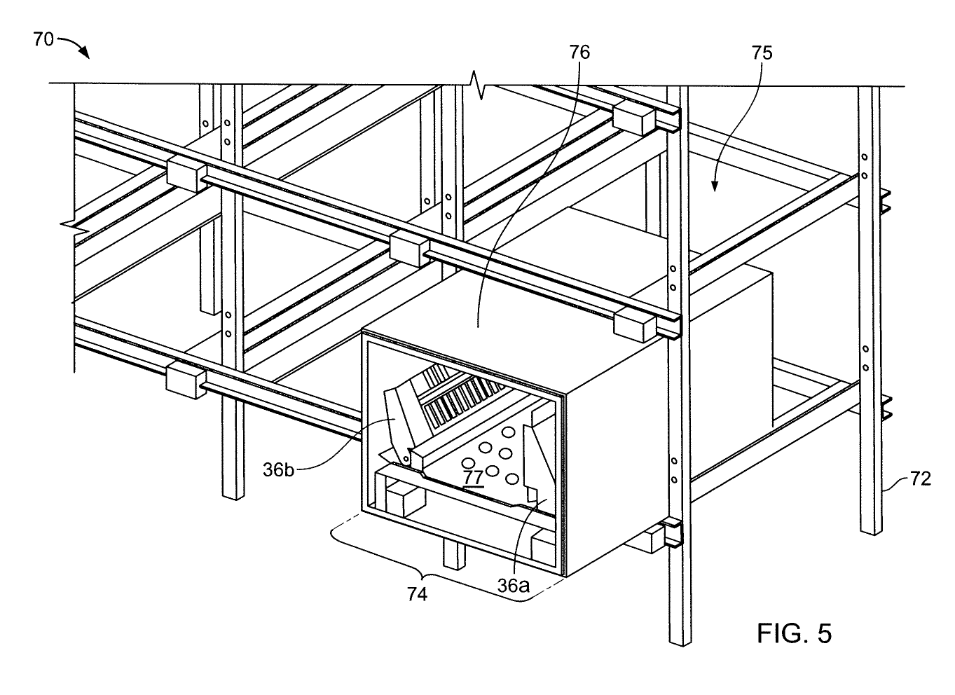

Referring to FIG. 5, system 70 for testing a storage cell includes rack 72 and formation bay assembly 74. In some examples, formation bay assembly 74 includes housing 76 with side walls, a bottom wall, and a top wall. In the illustrated example of FIG. 5, formation bay assembly 74 includes two contact assemblies 36a, 36b. Housing 76 encloses contact assemblies 36a, 36b, enabling for easy removal of the contact assemblies from slot 75 in rack 72. Formation bay assembly 74 includes space 77 to hold a “tote” (not shown), a device for holding the storage cells to be tested.

FIG. 6 shows an example of formation bay assembly 74. Formation bay assembly 74 includes contact assemblies 36a, 36b. Contact assembly 36a is affixed to support structure 80 by adjustable hinge 82. In some examples, support structure 80 is affixed to a wall of housing 76 (FIG. 5) of the formation bay assembly 74. Similarly, contact assembly 36b is affixed to support structure 80 by adjustable hinge 84. Contact assemblies 36a, 36b rotate about an axis of their respective hinges 82, 84 to accommodate various form factors of storage cells being tested. Hinges 82, 84 also provide for repeatable positioning of contact assemblies 36a, 36b within formation bay assembly 74. As hinge 82 rotates in direction 94, contact assembly 36a rotates in direction 94 until tabs 92a, 92b of storage cell 90 are enclosed in the testing space (i.e., tabs 92a, 92b of storage cell 90 are located between testing probe 10 and raised guide 56 (FIG. 4)).

Formation bay assembly 74 is also configured to hold tote 88, which holds storage cell 90. Storage cell 90 includes tabs 92a-92d protruding from the sides of storage cell 90. In order to test multiple storage cells simultaneously, tabs 92a-92d are arranged in an upper array and in a lower array. The placement and the number of tabs 92a-92d in the arrays correspond to the placement and the number of testing probes 10 in upper array 26a (FIG. 4) of testing probes 10 and in lower array 26b of testing probes 10.

As will be described in further detail below, raised feature 14a (FIG. 1) on testing probe 10 touches down to tabs 92a-92d to test storage cell 90. In some examples, a robot (e.g., an Automatic Storage and Retrieval System (“ASRS”) robot) is configured to move tote 88 in a side-to-side motion to engage tabs 92a-92d with testing probes 10 of contact assemblies 36a, 36b. In other examples, a robotic arm (not shown) moves contact assemblies 36a, 36b into a testing position in which tabs 92a-92d are engaged with testing probes 10 of contact assemblies 36a, 36b.

In the illustrated example of FIG. 6, contact assembly 36a is an “open position,” in which testing probes of contact assembly 36a do not make contact with tabs 92a, 92b. Contact assembly 36b is in a “closed position,” in which the testing probes of contact assembly 36b make contact with and test tabs 92c, 92d.

Referring to FIG. 7, rack 100 is configured to hold formation bay assembly 102. In this example, contact assembly 36 includes robotic arm 104. Referring back to FIG. 4, robotic arm 104 is inserted through opening 45 in formation electronics board 39, opening 43 in t contactor support board 38, and opening 58c in grid board 42a. Robotic arm 104 positions contact assembly 36 in a “test position,” a position in which raised features 14a-14e of testing probe 10 make contact with the tabs of the storage cell under test, as discussed in further detail below. In the illustrated example of FIG. 7, tote 106 holds a plurality of storage cells 107 to be tested. Each of the testing probes 10 of contact assembly 36 make contact with the tabs of storage cell 107 to be tested.

Testing of storage cells in a formation bay may be performed by a computer (not shown), e.g., by sending signals to and from a contact pad on the formation electronics board in the contact assembly. The testing may be performed using hardware or a combination of hardware and software. In this regard, any of the testing performed by the system described herein can be implemented, at least in part, via a computer program product, e.g., a computer program tangibly embodied in an information carrier, such as one or more machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Components of different embodiments described herein may be combined to form other embodiments not specifically set forth above. Components may be left out of the structures described herein without adversely affecting their operation. Furthermore, various separate components may be combined into one or more individual components to perform the functions described herein.

In some examples, the contact assembly includes the grid board 42 and the array 26 of testing probes 10 and the contactor support board 38 and formation electronics board 39 are integrated with external testing equipment. In this example, the contact assembly is fastened, for example manually, to the support board 38 to establish an electrical connection between the probes 10 and the contact pads on the formation electronics board.

In another example, the configuration of the formation bay assembly may be the same as that of FIG. 6, except that the formation bay assembly includes a single contact assembly.

The features described herein may be combined with any one or more of the features described in the following applications: U.S. Provisional Application No. ______, entitled “TEST SYSTEM” (Attorney Docket No. 18523-100P01/2236-US); U.S. patent application Ser. No. ______, entitled “ELECTRONIC DETECTION OF SIGNATURES” (Attorney Docket No. 18523-0119001/2234 US); U.S. patent application Ser. No. ______, entitled “REMOVING BAYS OF A TEST SYSTEM” (Attorney Docket No. 18523-0120001/2231-US); U.S. patent application Ser. No. ______, entitled “CALIBRATING A CHANNEL OF A TEST SYSTEM” (Attorney Docket No. 18523-0121001/2232-US); and U.S. patent application Ser. No. ______, entitled “ZERO INSERTION FORCE SCRUBBING CONTACT” (Attorney Docket No. 18523-0122001/2233-US). The contents of the following applications are incorporated herein by reference if set forth herein in full: U.S. Provisional Application No. ______, entitled “TEST SYSTEM” (Attorney Docket No. 18523-100P01/2236-US); U.S. patent application Ser. No. ______, entitled “ELECTRONIC DETECTION OF SIGNATURES” (Attorney Docket No. 18523-0119001/2234 US); U.S. patent application Ser. No. ______, entitled “REMOVING BAYS OF A TEST SYSTEM” (Attorney Docket No. 18523-0120001/2231-US); U.S. patent application Ser. No. ______, entitled “CALIBRATING A CHANNEL OF A TEST SYSTEM” (Attorney Docket No. 18523-0121001/2232-US); and U.S. patent application Ser. No. ______, entitled “ZERO INSERTION FORCE SCRUBBING CONTACT” (Attorney Docket No. 18523-0122001/2233-US).

Other embodiments not specifically described herein are also within the scope of the following claims.

What is claimed is:

1. A contact assembly for testing a storage cell, comprising:
a contact structure configured to flex in an outward direction to scrub and to pierce a tab of the storage cell;
a board, wherein a juxtaposition of the board to the contact structure defines an opening configured to receive the tab of the storage cell; and
a device configured to move the contact structure, to a position in which the opening is closed, to cause the contact structure to scrub and to pierce the tab on the storage cell.

2. The contact assembly of claim 1, wherein the tab is scrubbed at a zero insertion force.

3. The contact assembly of claim 1, wherein a portion of the contact structure comprises a raised feature and a flexure configured to flex in an outward direction upon a vertical application of force to the contact structure.

4. The contact assembly of claim 3, wherein the flexure causes the raised feature of the contact structure to scrub and to pierce a surface of the tab.

5. The contact assembly of claim 1, wherein the device is further configured to a move the board to a position in which the opening is closed.

6. The contact assembly of claim 1, further comprising:
a test system configured to receive one or more of the contact structure, the board and the device, for testing of the storage cell.

7. The contact assembly of claim 3, wherein the raised feature comprises one or more of a conducting material.

8. The contact assembly of claim 3, wherein the contract structure comprises one or more scalloped features configured to control a contact force applied to the tab on the storage cell.

9. The contact assembly of claim 3, wherein the raised feature comprises a first raised feature, and wherein the contact structure further comprises a first contact finger and a second contact finger, wherein the first contact finger comprises the first raised feature and the second contact finger comprises a second raised feature.

10. The contact assembly of claim 9, wherein the first raised feature of the first contact finger and the second raised feature of the second contact finger are each configured to pierce and to scrub the tab on the storage cell.

11. The contact assembly of claim 1, wherein the contract structure comprises an individually replaceable contact structure.

12. The contact assembly of claim 3, wherein the raised feature comprises an embossed, metallic contact tip.

13. The contact assembly of claim 1, wherein the contact structure comprises a first contact structure, and the contact assembly further comprises:
a second contact structure, wherein the first contact structure and the second contact structure are arranged in a contact array on a support board.

14. The contact assembly of claim 2, wherein the zero insertion force comprises a force that maintains a structure of the tab of the storage cell.

15. A method of testing a storage cell, the method comprising:
receiving a tab of the storage cell into a space between a board and a contact structure;
moving the contact structure to a position in which the space is closed; and
causing the contact structure to pierce and to scrub the tab on the storage cell using a raised feature on the contact structure.

16. The method of claim 15, wherein scrubbing and piercing are performed at a zero insertion force.

17. The method of claim 15, further comprising:
applying a vertical force, wherein application of the vertical force causes the contact structure to move in an outward direction, which causes the raised feature to pierce and to scrub the surface of the tab.

18. The method of claim 15, wherein the raised feature comprises a first raised feature, the contact structure comprises a first contact finger and a second contact finger, and wherein the first contact finger comprises the first raised feature and wherein the second contact finger comprises a second raised feature, and wherein the method further comprises:
causing the contact structure to pierce and to scrub a surface of the tab on the storage cell with the first raised feature and the second raised feature.

19. The method of claim 15, wherein the raised feature comprises a conducting material.

20. A contact assembly for testing a storage cell, comprising:
a probe configured to flex in an outward direction, in response to a vertical application of force, to scrub a tab on the storage cell at a zero insertion force.
